(19) United States
(12) Patent Application Publication
(10) Pub. No.: US 2012/0223076 A1
(43) Pub. Date: Sep. 6, 2012

(54) CUP SYSTEM WITH REMOVABLE INSULATED LINER

(75) Inventors: Robert J. Godfrey, Baraboo, WI (US); Richard H. Gates, Wisconsin Dells, WI (US); Brian M. Albrecht, Baraboo, WI (US)

(73) Assignee: NUK USA LLC, Hackensack, NJ (US)

(21) Appl. No.: 13/304,616

(22) Filed: Nov. 25, 2011

Related U.S. Application Data
(60) Provisional application No. 61/421,534, filed on Dec. 9, 2010.

(51) Int. Cl. B65D 51/00; B65D 53/00; B23P 19/04; B65D 41/04

(52) U.S. Cl. 220/288; 220/200; 220/378; 29/428

(57) ABSTRACT

A cup system including a lid, a liner, an outer cup, and an optional valve. The liner includes first and second mating surfaces. The liner first mating surface is selectively attachable to a corresponding mating surface associated with the outer cup and the liner second mating surface is selectively attachable to a corresponding mating surface associated with the lid. The mating surface of the lid is also selectively attachable to the mating surface of the outer cup such that present cup can be utilized as either an insulated or a non-insulated cup. The optional valve assembles to the lid by pressing the boss of the valve into a valve receiver associated with the lid.

### CROSS-REFERENCE

This application claims the benefit of and priority to U.S. Provisional Patent Application Ser. No. 61/421,534, filed Dec. 9, 2010, entitled CUP SYSTEM WITH REMOVABLE INSULATED LINER, which application is hereby incorporated by reference to the extent permitted by law.

### BACKGROUND OF INVENTION

Cups intended to hold hot and cold liquids are generally insulated to maintain the temperature of the liquid for as long as possible. Spill-proof cups have also become ubiquitous. Spill-proof cups are used by almost everyone from toddlers (using the “sippy” cups) to adults and everyone in between engaging in physical activities. Spill-proof cups may have a lid with an opening that can be opened or closed with a mechanical closure. These closures can be made according to different designs. For toddlers, the sippy cups may include a valve that requires the toddler to create suction to draw the liquid out of the cup. The objective of spill-proof cups is to retain liquid within the cup if dropped or knocked on its side.

### SUMMARY OF INVENTION

Cups that contain a liquid that is at a different temperature than the ambient temperature around the cup are subject to thermal transfer. When the removable cup liner is assembled into the outer cup body, a thermal barrier is created. The thermal barrier includes trapped air in between the liner and outer cup body. Current insulated cups are typically constructed of a liner mechanically bonded permanently to an outer cup body. At the point where the two parts are bonded, there is a junction in which contaminates may be trapped. The trapped contaminates can be inaccessible to clean. Also, if the mechanical bond fails, contaminates can pass into the air compartment in between the liner and outer cup body. With the liner bonded to the outer cup body, there is no way to clean in between the two parts. In one embodiment disclosed herein, a cup is provided with a removable liner, where the exterior and interior surfaces of the liner and outer cup body can be cleaned.

Mechanically bonded insulated cups require an additional process during manufacturing to bond the liner to the outer cup. With a removable liner, the liner may just be inserted into the cup during product peak out.

Mechanically bonded insulated cups have tight process parameters to avoid undesirable bonds, such as flash or gaps in the bonded junction between the liner and outer cup body. Tight process parameters lead to high scrap rates and longer manufacturing cycles. With a removable liner, this step may be eliminated in the manufacturing process for an insulated cup.

Insulated cups on the market are produced in high volumes. It is likely that while using an insulated cup, the user will come across an identical insulated cup. An insulated cup with a removable liner can be customized by the user, by inserting a picture or art work in between the liner and outer cup body. In one embodiment, the disclosed cup system allows for the placement of a picture or art work in between the liner and the outer cup body. To view the picture or artwork, the outer cup can be made from a transparent material and the liner can be made from an opaque or transparent material, such as pigmented plastics or polymers. The outer cup and liner can be made from materials capable of holding both hot and cold liquids, such that very hot liquids, such as boiling water or frozen water will not damage the materials. The material for the liner or outer cup body could be plastic or metal.

Disclosed is a cup system including a lid, valve, liner, and outer cup. The valve assembles to the lid by pressing the boss of the valve into the valve receiver of the lid. Once the valve and lid are assembled, the lid assembly can be threaded onto either the outer cup body (to be used as a non-insulated cup) or to the liner that would get threaded to the outer cup body (to be used as an insulated cup).

In one embodiment, the user can choose to configure the cup system as an insulated cup (with liner) or a non-insulated cup (without liner).

In one embodiment, the insulated cup provides the ability of cleaning all the surfaces of all the cup components. The parts can be disassembled for access to clean all surfaces.

In one embodiment, the cup system provides a double threaded liner. The liner has two threaded sections. The first thread on the liner is an external thread that can be assembled to the lid. This thread design is the same as the external thread design on the outer cup body. The second thread on the liner is an internal thread design that can be assembled to the outer cup body. When the liner is threaded onto the cup body, there is an airtight seal trapping the air in between the liner and outer cup body. As the liner and outer cup body are threaded together, the top outer diameter edge of the outer cup body engages a conical ramp on the liner in the top of the internal threaded section. As the liner and outer cup body are further threaded to maximum thread engagement, the conical ramp is compressing the top outer diameter edge of the cup creating an airtight seal.

Manufacturing a double-threaded liner with both internal and external threads may be accomplished by using a sliding lifter in the mold to allow for the internal threads to jump over the tool during ejection.

In one embodiment, the liner and outer cup body can have printed graphics.

In one embodiment, the user can mix and match components that have different colors and graphics.

In one embodiment, the removable liner insulated cup could be used with or without a lid.

In one embodiment, handles could be attached to the lid or the liner or the cup body. Additional components could be included, for example, handles, a belt clip, hood, or tether.

In one embodiment, the outer cup body could have an internal thread that mates with an external thread on the liner.

In one embodiment, gaskets can be used to provide sealing between the lid and the liner, the liner and the outer cup, and the lid and the outer cup. The gaskets could be permanent or removable.

In one embodiment, the mating structure or the means to join or otherwise attach the outer cup to the liner, the liner to the lid, or the outer cup to the lid can include one or a combination of the following: screw treads, snap fit, or interference fit.

In one embodiment, more than one liner can be used, each liner having an external set of threads and an internal set of threads, wherein multiple liners can be stacked inside each other.

In one embodiment, a second liner could be used as the outer cup.

In one embodiment, solids, liquids, fluids, and gases, or any combination may be included between the space between the outer cup and a liner, or if more than one liner is being used, a space created between a first and a second liner.

In one embodiment, the liner may not include any threads, such that the liner can be inserted into the outer cup and secured when the lid is attached to the outer cup.

In one embodiment, the lid may have two sets of threads, one for the liner and one for the outer cup.

In one embodiment, the outer cup may have two sets of threads, one for the lid and one for the liner.

One or more of the features of the disclosed cup can be used in any container, including, but not limited to, baby bottles, snack cups, coffee mugs, and sports bottles.

### BRIEF DESCRIPTION OF DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of a cup in accordance with one embodiment of the invention.

FIG. 2 is a diagrammatical illustration of an exploded view of the cup illustrated in FIG. 1.

FIG. 2B is a diagrammatical illustration of an exploded view of an alternative cup configuration for the cup illustrated in FIG. 1.

FIG. 3 is a diagrammatical cross-sectional illustration of the cup illustrated in FIG. 1,

FIG. 4A is a cross-sectional illustration of a detail view of the mating structure of the cup illustrated in FIG. 1.

FIG. 4B is a cross-section illustration of a detail view of the mating structure of the alternative cup configuration for the cup illustrated in FIG. 1.

FIG. 5 is a diagrammatical illustration of a cup in accordance with one embodiment of the invention.

FIG. 6 is a diagrammatical illustration of an exploded view of the cup illustrated in FIG. 5.

FIG. 7 is a cross-sectional illustration of the cup illustrated in FIG. 5.

FIG. 8 is another embodiment of the cup system in accordance with one embodiment of the invention.

### DETAILED DESCRIPTION

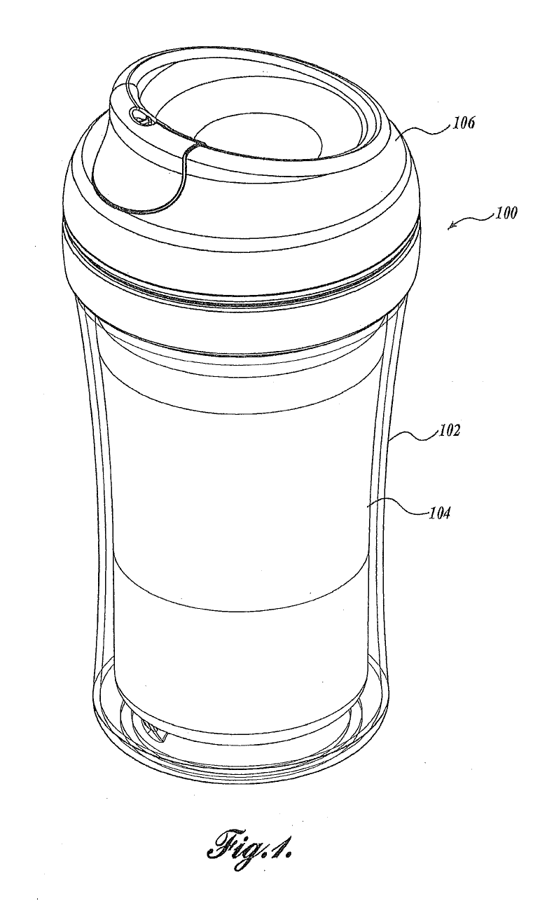

FIG. 1 is an illustration of a cup system 100 including an outer cup 102, an inner liner 104 and a lid 106. The outer cup 102 is formed from a cylindrical-shaped body having a closed end on the bottom and an open end on top to provide a container for liquids and/or the liner 104. The cup system 100 includes a removable liner 104. The liner 104 can be, provided for insulation in which case the liner 104 can hold the liquid. Alternatively, the liner 104 can be omitted in an alternative configuration of the clip system 100. The liner 104 is formed from a cylindrical shape having a closed bottom and an open top. The dimensions, such as the diameter, of the liner 104 may be smaller than the dimensions of the outer cup 102 so that the liner 104 may be placed within the cup 102 to provide a space between the liner 104 and cup 102. The cup system 100 includes a lid 106. The lid top surface if depressed in a concave manner, while the lid 106 lower surface includes a valve 108, which will be described below.

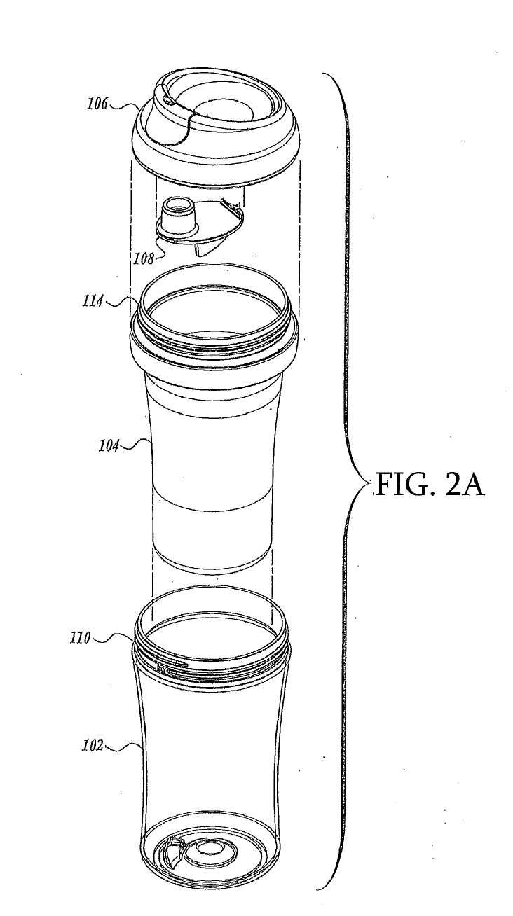

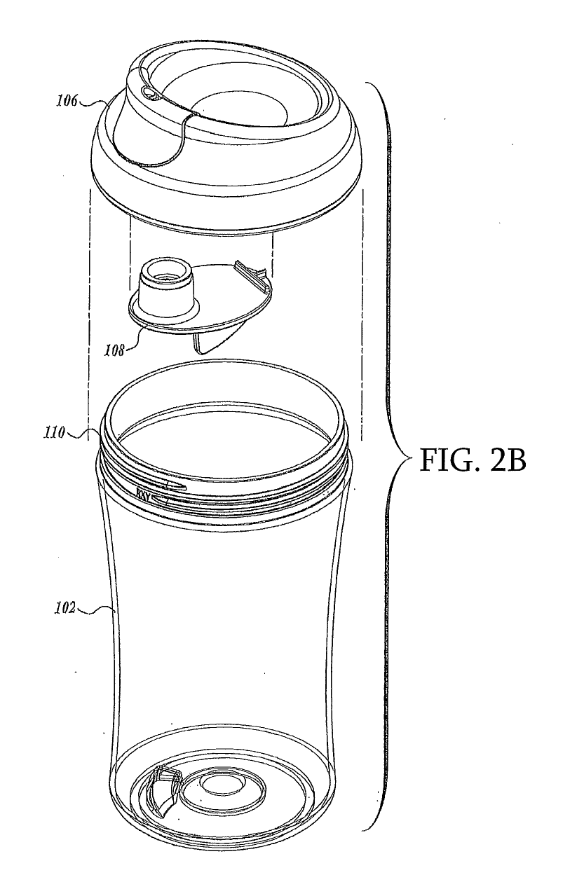

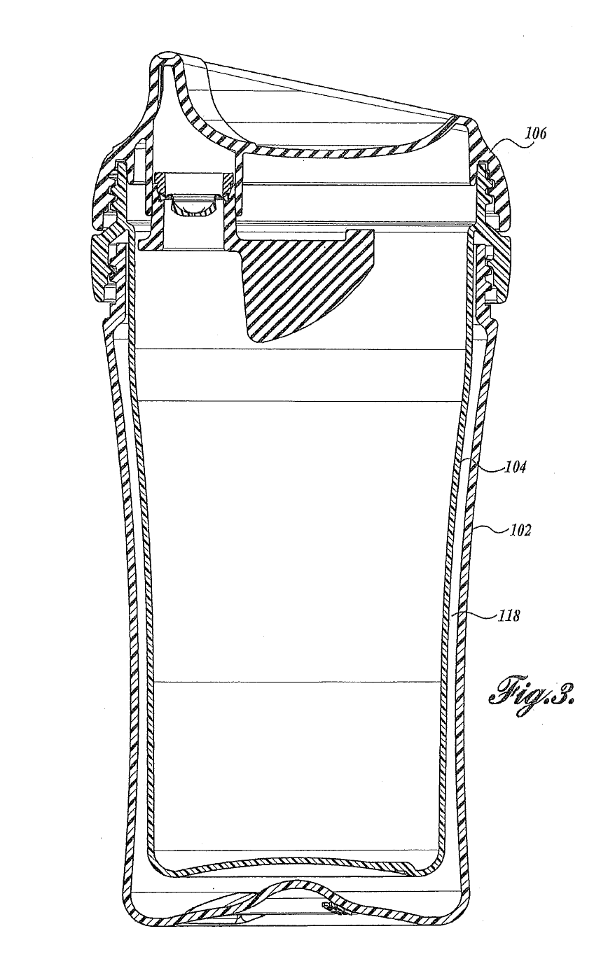

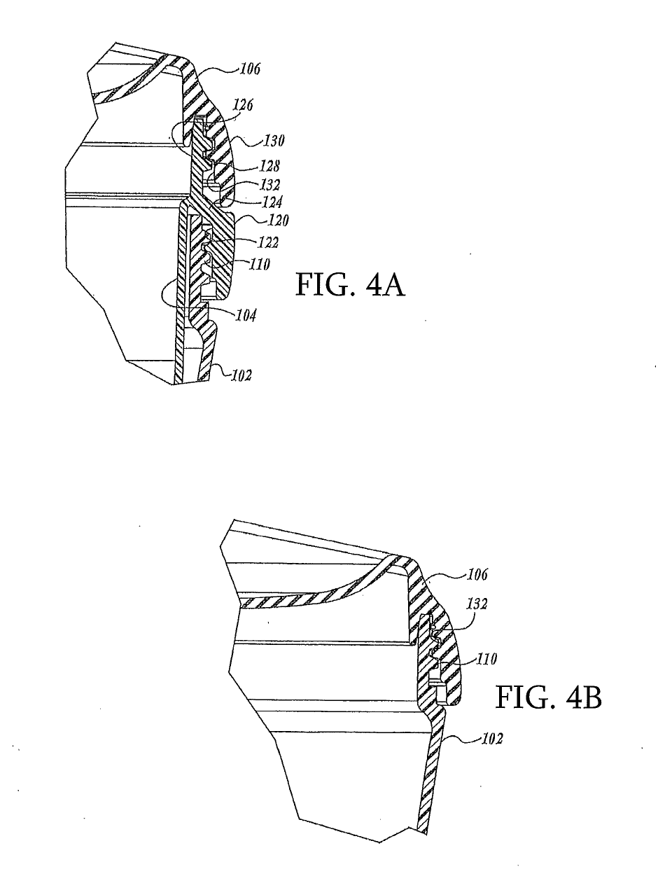

Referring to FIG. 2A, the components of the cup system 100 are shown. The outer cup 102 includes a mating surface 110 on the upper portion thereof and positioned below or at the opening of the cup 102. In one embodiment, the mating surface 110 can include screw threads on the exterior of the cup 102 as the means for mating the cup 102 to the liner 104 or to the lid 106. The inner liner 104 fits inside of the depression of the outer cup 102, so as to create a space between the interior cylindrical wall of the outer cup 102 and the exterior cylindrical wall of the liner 104. The liner 104 includes two mating surfaces. A first mating surface can be formed on the exterior side of the upper portion of the liner 104 and positioned below or at the opening of the liner 104. A second mating surface can be formed from an annular band 120, as best seen in FIG. 4A. In one embodiment, the first mating surface includes exterior screw threads and the second mating surface includes interior screw threads.

The valve 108 is a valve similar to the valve disclosed in U.S. Pat. No. 5,890,621, fully incorporated herein expressly by reference. The valve 108 is optional and need not be included in embodiments of the cup. The valve 108 allows fluid to flow out of an aperture formed in a spout created in the lid 108 or to allow air to flow back into the cup. Accordingly, the valve 108 may be included in cups for training toddlers to drink from cups in a transition period following bottle feeding.

Referring to FIG. 3, the lid 106 includes an upper surface that is concave in shape, wherein one side is higher in elevation so as to create a spout. The spout includes an aperture at the upper end thereof for withdrawing liquids from the cup. Below the spout, a cylindrical opening (the valve receiver) is provided to which the valve 108 may be secured through the valve boss. As seen in FIG. 4A, the lid 106 includes a mating surface 130 at a location on the interior of the lower end 130 of the lid 106. In one embodiment, the mating surface includes screw threads 132.

Referring to FIG. 2B, an alternative configuration of the cup system 100 is illustrated, wherein the outer cup 102 excludes the liner 104. A feature of the cup system is that the mating surface 110 of the outer cup 102 is configured to mate with one of the two mating surfaces of the inner liner 104. The mating surface 110 of the outer cup 102 is also configured to mate with the mating surface of the lid 106. Accordingly, the cup system can be built as an insulated (with liner) cup including an outer cup 102 mated to the inner liner 104 and the inner liner 104 is mated with the lid 106. In this configuration, the outer cup 102 is not mated with nor in contact with the lid 106. In an alternative configuration, the cup system can be built as a non-insulated (without liner) cup including an outer cup 102 mated only to the lid 106, without the liner 104.

Referring to FIG. 3, a cross-section illustration is shown. As discussed above, placement of the liner 104 within the cup 102 creates a space 118 between the interior wall of the outer cup 102 and the exterior wall of the inner liner 104. This space 118 is an annular space and may include bottom space defined by the interior bottom wall of the cup 102 and the exterior bottom wall of the liner 104, as well. Thus, providing insulating capacity surrounding the outer cup 102. The space 118 can be filled with any solid, liquid, or gas. In one embodiment, water may be provided in the space 118 may then be placed in a freezer for freezing the water. This provides a way of maintaining or prolonging the temperature of cold liquids as the ice melts within the space 118.

Referring to FIG. 4A, a detailed view of the mating surfaces of the outer cup 102, the inner liner 104, and the lid 106, are shown. The cup 102 includes the mating surface 110. In one embodiment, the mating surface can include exterior or male screw threads. The liner 104 includes a first mating surface 128, wherein the surface can be provided with exterior or male screw threads. The liner 104 also includes a second mating surface provided with interior or female screw threads. The interior female threads 122 are provided on the inside surface of the band 120 circling the liner 104 near the upper open end of the inner liner 104. There is a juncture at the point where the cylindrical body of the liner 104 connects to the uppermost rim 126 that forms the first mating surface for the threads 128. At this juncture, there is a downwardly projecting joining member 124 that connects the band 120 supporting the second mating surface to the cylindrical body of the liner 104. The bank 120 is therefore spaced from the exterior wall of the liner 104 allowing for the inclusion of the second mating surface 122 and the separation of the band 120 from the liner 104 wall further allows the mating surface 110 of the outer cup 102 to mate with the second mating surface 122 of the liner 104.

In one embodiment, the pitch of the screw threads on the mating surface 110 of the outer cup 102 is the same as the pitch of the screw threads on the first mating surface 128 of the liner 104. Further, the pitch of the screw threads on the second mating surface 122 of the liner is the same as the pitch of the screw threads on the mating surface 132 of the lid. The reason why the mating surface of the outer cup 102 and the first mating surface 128 of the liner 104 are similar is to allow the lid 106 to mate with the liner 104 at the first mating surface 128 and to also allow the lid 106 to'mate with the outer cup 102 at the mating surface 110 without the liner. This latter embodiment is shown in FIG. 4B, wherein the mating surface 110 of the outer cup 102 is mated with the mating surface 132 of the lid 106. In the embodiment shown in FIG. 4B, the liner 104 is omitted.

Accordingly, the cup system according to one embodiment of the invention can be provided with an insulated liner 104, and in another embodiment, the cup system can be provided without an insulated liner.

Although screw threads have been illustrated as one embodiment used in mating surfaces, other mating surfaces are possible. For example, mating surfaces might include press-fit surfaces with or without an O-ring seal, or mating surfaces where the threads are positioned on opposite sides. For example, rather than having exterior male threads in the outer cup 102, the outer cup 102 can have interior female threads. Likewise, instead of having exterior male threads 128 as a first mating surface of the liner 104, the threads can be interior female threads. Also the second mating surface 122 of the liner, instead of having interior female threads, can be provided with exterior male threads. The interior female threads of the lid 106 can be provided as exterior male threads. Other different mating surfaces can be provided, such as either a left hand thread or a right hand thread. Another embodiment might include threads on the exterior of the cup 102 and threads on the interior of the lid 106. However, the liner can be built omitting any threads and simply have a planar rim (such as a disk) that is squeezed between a surface of the upper portion of the outer cup 102 and a lower portion of the inside of the lid 106.

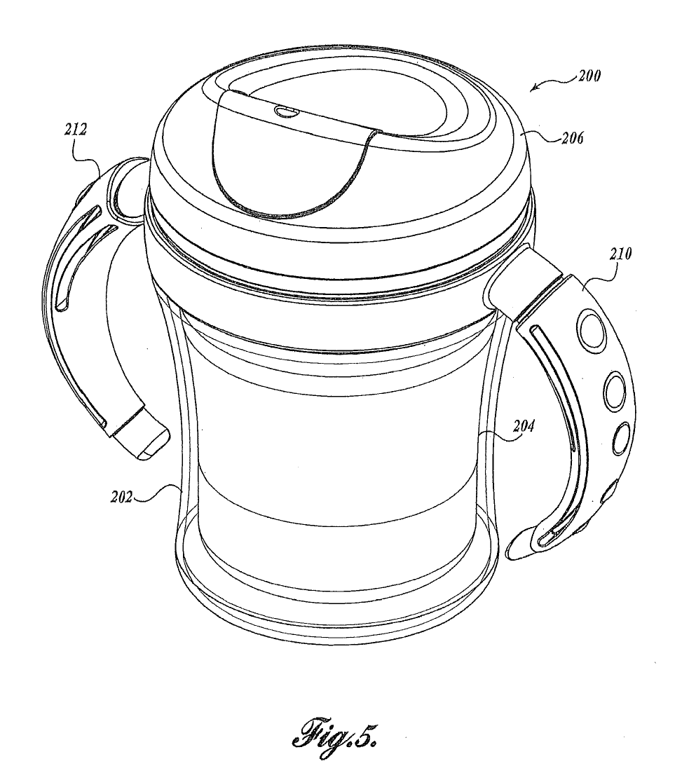

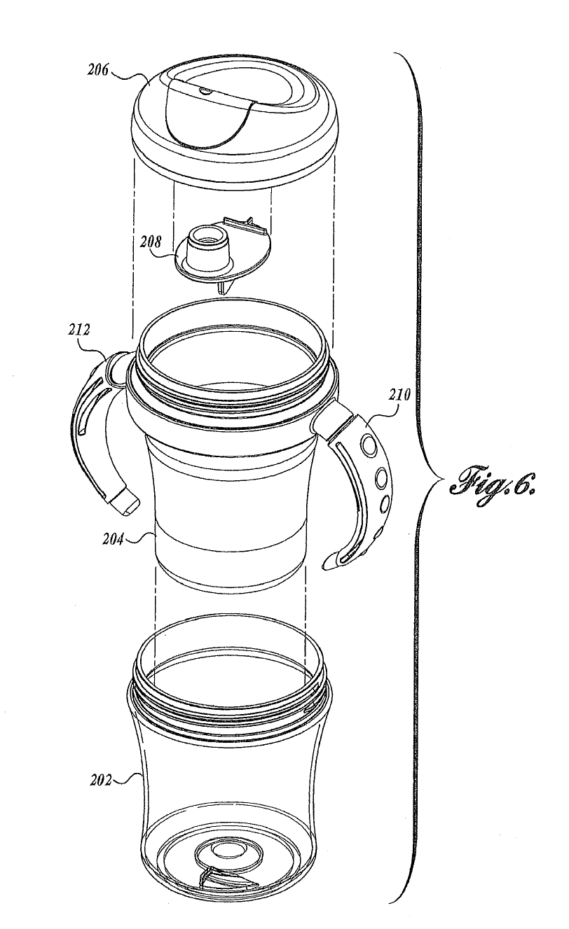

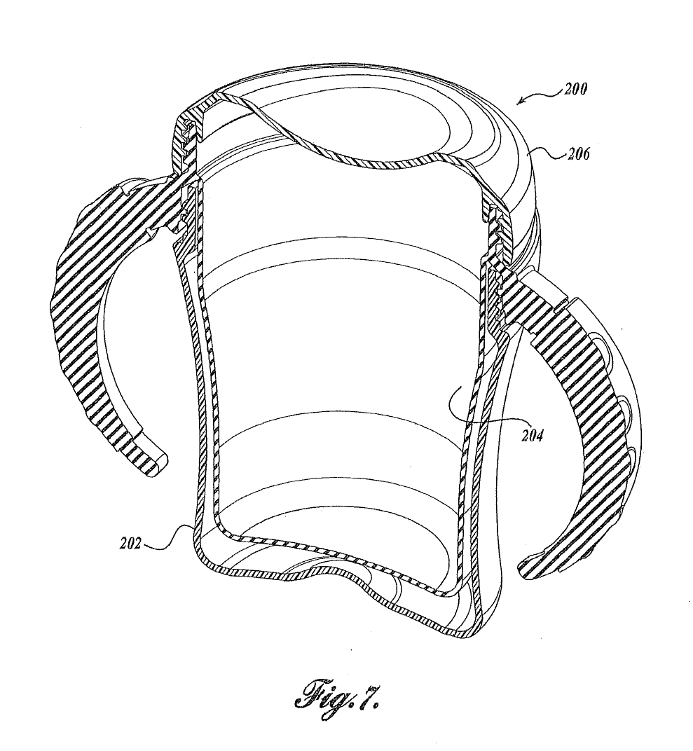

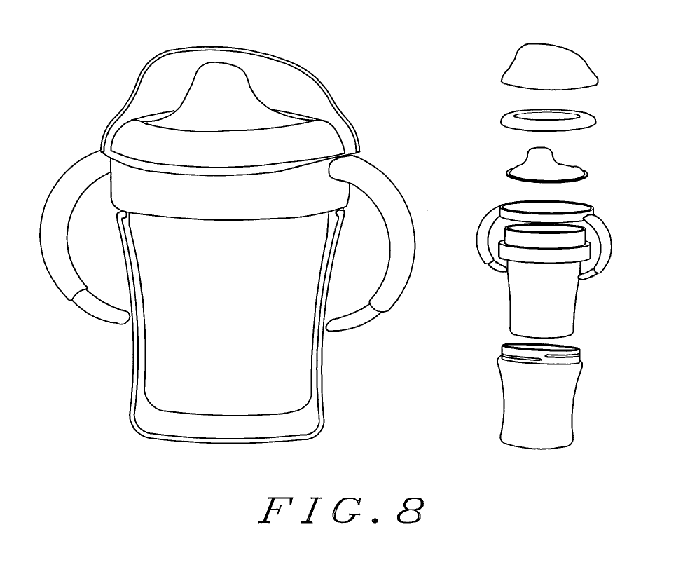

FIG. 5 shows an alternative cup system 200. The cup system 200 is in many respects similar to the cup system 100 of FIGS. 1-4. However, the cup system 200 can be made of a smaller size to hold a smaller amount of liquid for infants and toddlers. Additionally, the liner 204, as seen in FIG. 6, can be made with left and right handles 210 and 212. Alternatively, the handles can be provided on the outer cup 202, or on a separate ring as illustrated in FIG. 8. The cup system 200 similarly includes an outer cup 202, a liner 204, a valve 208, and a lid 206. As seen in FIG. 7, the cup system similarly provides a space between the outside of the liner 204 and the inside of the cup 202 so as to provide a space for solids, liquids, or gases. Water may be placed within the space and frozen. Similarly, the interior liner 204 can be part of the cup system in one embodiment, and omitted in a second embodiment of the cup system 200. Accordingly, mating surfaces between the outer cup 202 and the liner 204, and mating surfaces between the liner 204 and the lid 206 are made so as to allow mating of the lid 206 to both the liner 204 and the outer cup 202, as described above.

While illustrative embodiment have been illustrated and described, it will be appreciated that various changes can be made therein without departing from the spirit and scope of the invention.

The embodiments of the invention in which an exclusive property or privilege is claimed are defined as follows:

1. A cup system comprising:
an outer cup with an interior and a mating surface;
a liner with first and second mating surfaces, wherein the first mating surface of the liner is configured to selectively mate with the mating surface of the outer cup; and
a lid with a mating surface, wherein the mating surface of the lid is configured to selectively mate with the second mating surface of the liner and the mating surface of the outer cup.

2. The cup system of claim 1 wherein the mating surface of the outer cup and the second mating surface of the liner include external male threads, and the first mating surface of the liner and the mating surface of the lid include internal female threads.

3. The cup system of claim 2 wherein male threads of the outer cup mating surface and the liner second mating surface have substantially the same pitch and the same major and minor diameters, and the female threads of the lid mating surface and the liner first mating surface have substantially the same pitch and the same major and minor diameters.

4. The cup system of claim 1 wherein the mating surface of the outer cup and the second mating surface of the liner include internal female threads, and the first mating surface of the liner and the mating surface of the lid include external male threads.

5. The cup system of claim 4 wherein female threads of the outer cup mating surface and the liner second mating surface have substantially the same pitch and the same major and minor diameters, and the male threads of the lid mating surface and the liner first mating surface have substantially the same pitch and the same major and minor diameters.

6. The cup system of claim 1 wherein mating the liner to the outer cup results in an air-tight seal.

7. The cup system of claim 1 wherein mating the lid to the liner results in an air-tight seal.

8. The cup system of claim 1 wherein mating the lid to the outer cup results in an air-tight seal.

9. The cup system of claim 1 further including a valve secured to the lid for selectively allowing liquid through a hole in the lid.

10. The cup system of claim 1 wherein selectively mating the liner with the outer cup leaves an insulating space between the liner and the outer cup.

11. The cup system of claim 1 further including at least one handle attached to the outer cup.

12. A cup system comprising:
an outer cup with a mating surface at an upper end thereof;
a liner with a first mating surface at an upper end thereof and a second mating surface below the first mating surface, wherein the outer cup mating surface is selectively attachable to the second mating surface of the liner, and wherein selectively mating the liner with the outer cup forms a space between the liner and the outer cup; and
a lid with a mating surface at a lower end thereof, wherein the mating surface of the lid is selectively attachable to the first mating surface of the liner.

13. The cup system of claim 12 wherein the mating surface of the lid is selectively attachable to the mating surface of the outer cup.

14. A method for creating a cup comprising the steps of:
providing an outer cup having a mating surface;
configuring a liner to fit within the outer cup such that a space exists between the liner and the outer cup;
configuring said liner to have first and second mating surfaces, the first mating surface thereof being configured to selectively mate with the mating surface of the outer cup when said liner is placed within said outer cup, where said selective mating forms an air-tight seal to contain any substance residing in the space between the liner and the outer cup; and
providing a lid having a mating surface which may be selectively mated to the outer cup mating surface or the second mating surface of the liner.
